(19) United States
(12) Patent Application Publication
(10) Pub. No.: US 2015/0030520 A1
(43) Pub. Date: Jan. 29, 2015

(54) TRICHLOROSILANE PRODUCTION

(71) Applicant: CENTROTHERM PHOTOVOLTAICS USA, INC., Poulsbo, WA (US)

(72) Inventor: Mark William Dassel, Poulsbo, WA (US)

(73) Assignee: CENTROTHERM PHOTOVOLTAICS USA, INC., Poulsbo, WA (US)

(21) Appl. No.: 14/380,725

(22) PCT Filed: Mar. 13, 2013
(86) PCT No.: PCT/US13/30860

§ 371 Date: Aug. 24, 2014

Related U.S. Application Data
(60) Provisional application No. 61/610,941, filed on Mar. 14, 2012.

(51) Int. Cl. C01B 33/107

(52) U.S. Cl. CPC C01B 33/10763; C01B 33/1071
USPC 423/342

(57) ABSTRACT

A process that includes combining hydrogen chloride, metallurgical grade silicon and a third gas, e.g., tetrachlorosilane, in a reactor, under reaction conditions that include a temperature of 250-400 C. and a pressure of 2-33 barg, for a time sufficient to convert metallurgical grade silicon to an exit gas that includes trichlorosilane.

### FIELD OF THE INVENTION

The present invention relates generally to chemical processes and more specifically to chemical processes that produce chlorosilane; thereby affording economical access to, for example, photovoltaics, semiconductors and integrated circuits.

### BACKGROUND

### Technical Field and Description of Related Art

Highly pure silicon is used to make solar cells and semi-conductor chips, both of which are an integral part of the current economy. On a commercial scale, highly pure silicon is made from highly refined tri-chlorosilane (TCS) in a process known as Siemens' continuous vapor deposition (or CVD). In the Siemens' reaction, TCS is converted to polysilicon (Si, the desired product), and STC and hydrogen as by-products, according to the chemical reaction:

4TCS→1Si+3STC+2H₂ (plus other by-products)

From the preceding chemistry, it is seen that approximately ¾^{ths} of the TCS that decomposes in a CVD reactor produces STC by-product. The Siemens' process produces the desired polysilicon, however it also produces undesirable by-products, such as silicon tetrachloride (STC) and hydrogen chloride, which are recovered as part of an off gas that also typically includes unreacted starting materials (TCS and hydrogen). The suitable utilization and/or disposal of this off gas has a significant impact on the overall economics of the polysilicon production process. In the early days of the polysilicon industry, the STC by-product was sent to waste or converted to saleable products such as fumed silica. Today, modern plants make use of STC by converting it back to TCS, primarily by one of two ways: in an electrically driven high-temperature STC converter reactor, or by STC hydrochlorination, i.e., by reacting STC with MGSi to produce TCS. One option for utilizing the off gas is to convert some of the components back to TCS, where the TCS can be used as a feedstock for the Siemens' process. The two processes typically used to manufacture TCS, which can be incorporated into a polysilicon production facility, are “direct chlorination” and “STC hydrochlorination”, described as follows.

In direct chlorination, hydrogen chloride (HCl) is reacted with metallurgic silicon (MGSi) to produce TCS and hydrogen (H₂) according to chemical reaction:

3HCl+1MGSi→1TCS+1H₂

Direct chlorination typically takes place in fluidized bed reactor operating at, for example, 3 barg pressure and 300° C. temperature. The reaction is catalyzed by molecular species comprising copper trichloride. The reaction proceeds to substantial completion, based on HCl conversion. STC is typically a by-product of the direction chlorination reaction, where the molar ratio of TCS:STC produced is substantially equilibrium controlled—contingent on a fluid bed reactor with sufficient hold up time.

In STC hydrochlorination, silicon tetrachloride (STC) is reacted with hydrogen and metallurgic silicon to produce TCS according to the chemical reaction:

3STC+2H₂+1MGSi→4TCS

STC hydrochlorination typically takes place in fluid bed reactors operating at, for example, 33 barg and 550° C. to 550° C. temperature. The reaction is catalyzed by molecular species comprising copper trichloride, and typically proceeds to equilibrium. The reaction is typically operated using a stoichiometric excess of STC in the feedstock.

The direct chlorination process to produce TCS has significant shortcomings. For instance, direct chlorination suffers from the problem that by-product STC produced in the CVD process is not utilized in the direct chlorination process, and thus a separate process must be set up whereby STC is converted at high capital and operating cost back to TCS, according to the following chemistry:

STC+H₂→TCS+HCl (plus other by-products)

This reaction takes place under high temperature (e.g., 1100° C. to 1300° C.), in capital intensive, electrically driven reactors (a.k.a., “hot converters”) specially designed for the purpose. The high temperature is achieved by electrically heating graphite electrodes, located inside the reactors. The hot converters are costly to build and operate because of the required high temperature operation, relatively low conversion per pass (only 15% to 25% of the STC feed is converted to TCS per pass), and high maintenance cost (the electrode and graphite block insulation systems require frequent replacement due to wear and tear). The graphite electrodes also introduce unwanted carbon impurities into the TCS product stream, in the form of methane and/or methyl-chlorosilanes. Unless removed, the methane and/or the methyl-chlorosilanes travel with the regenerated TCS back to the CVD reactor, where they can decompose and introduce unwanted carbon into the polysilicon product. Carbon contamination in polysilicon is undesirable because it can render the polysilicon unfit for use in the photovoltaic and semiconductor industries.

There are other problems with the direct chlorination process. For instance, product gases exiting the hot converters must be recovered in a costly to build and operate vent gas recovery (VGR) process system. Yet another problem is that HCl produced in the hot conversion process must be isolated and stored as a gas or a cryogenic liquid for recycle back to the direct chlorination reactors. This isolation and storage is difficult to perform, costly to operate, and hazardous to the plant operating personnel and surrounding community due to the high toxicity of the HCl.

Yet another problem with the standard direct chlorination reaction is obtaining the starting HCl reactant in a pure form. According to current industrial practice, all materials in the hot converter off-gas must be separated into substantially pure component streams to avoid co-feeding TCS, STC, and/or hydrogen with the HCl recycle to the direct chlorination reactor, as co-feeding is thought to have deleterious effects. For example, it is believed that feeding TCS to the direct chlorination reactor results in over-chlorination, resulting in the unwanted production of additional STC. It is believed that feeding STC to the direct chlorination reactor results in the dilution of TCS in the reactor product, thereby necessitating unwanted additional TCS/STC separation distillation downstream of the direct chlorination reactor. It is believed that feeding hydrogen to the direct chlorination reactor complicates the off-gas treatment system, as hydrogen must be separated from TCS in the off-gas. Accordingly, the standard direct chlorination reaction is operated using highly pure HCl, where production of such high purity HCl from Siemens' process off gas is expensive in terms of operating cost and equipment, since that off gas contains many components which must be separated from the HCl.

The STC hydrochlorination process solves some of the problems associated with the direct chlorination process; however, in so doing it brings new problems. Some of these problems are associated with the much higher operating temperature required for STC hydrochlorination (500° C. to 550° C. for STC hydrochlorination vs. around 300° C. for direct chlorination). This higher operating temperature contributes to the need to run the fluid bed reactor at relatively high pressure (e.g., 33 barg for STC hydrochlorination vs. 3 barg for direct chlorination). High pressure is required to compress the gas in the reactor such that the required hold up time for the reaction can be achieved in a reasonably sized reactor. Reactors that operate at high temperature and high pressure are relatively expensive to build, run and maintain. For example, such reactors may be built from expensive alloys (e.g., Incoloy 800H) in order to achieve high strength at high temperatures, which drives up plant capital cost. In order to run such reactors efficiently, it is typically necessary to install electrically heated equipment to superheat hydrogen and STC feed gases to the STC hydrochlorination reactor operating temperature. This, of course, increases the capital equipment and operating cost for a plant that utilizes this process. In addition, such reactors have inherent safety hazards, which are significant. A major release of STC hydrochlorination reactor content could have catastrophic effects on plant personnel and the surrounding community, resulting in loss of life and extensive destruction of capital equipment.

Another problem with STC hydrochlorination is the low conversion per pass across the STC hydrochlorination reactor. Typically only 20% to 25% of the STC fed is converted to TCS, compared to almost 100% HCl conversion in a direct chlorination reactor. The low conversion per pass across the STC hydrochlorination reactor results in the generation of large STC recycle streams, with concomitant expense in capital equipment and plant operating cost.

Yet another problem associated with the use of STC hydrochlorination is that the relocation of the STC recovery process from the back-end of the plant (i.e., the “clean end” of the plant downstream of the CVD reactors) to the front-end of the plant (i.e., the “dirty end” of the plant in the fluid bed reactors) means that the intervening TCS purification processes (purification is substantially performed in large distillation columns) must be sized as much as 4× larger than those required for direct chlorination.

### SUMMARY

The present invention provides a great revitalization of existing direct chlorination plants world-wide—making them less costly to run than current STC hydrochlorination plants, and making back-conversion to a process comprising the present invention economic. It also opens the path to a new TCS synthesis reactor technology. In one embodiment, this new path hybridizes direct chlorination and STC hydrochlorination. This hybridized technology is less costly to build and operate than either direct chlorination or STC hydrochlorination, and far safer than STC hydrochlorination.

In one embodiment, the invention provides a process comprising combining feedstock materials comprising hydrogen chloride, metallurgical grade silicon, and a third feedstock material (M3) selected from tetrachlorosilane (STC), trichlorosilane (TCS), dichlorosilane (DCS) and hydrogen (H2) in a reactor. The reactor is operated under reaction conditions comprising a temperature of 250-400° C. and a pressure of 2-33 barg and a range therein as described herein, for a time sufficient to convert metallurgical grade silicon to trichlorosilane, where the trichlorosilane leaves the reactor as a component of an off-gas. The reactor may include a fluidized bed formed, in part, from particles of MGSi. The reactor may further include a Lewis acid to catalyze the formation of TCS. The third feedstock material may be in combination with one or more of the listed M3 options, e.g., feedstock material may include both STC and TCS. Exemplary embodiments of the invention are described as follows:

In one embodiment, provided herein is a process comprising combining trichlorosilane, hydrogen chloride, and metallurgical grade silicon in a reactor under conditions to provide a product mixture comprising trichlorosilane at a higher concentration than is present in the starting material, i.e., the process produces “new” trichlorosilane in that the product contains more trichlorosilane than is introduced into the reactor. The reaction conditions may be a temperature of 250-400° C. and a pressure of 2-33 barg, or 2-20 barg, or 2-10 barg, or 2-7 barg, for a time sufficient to convert metallurgical grade silicon to trichlorosilane. In one embodiment, the molar concentration of trichlorosilane in the product mixture is greater than the molar concentration of trichlorosilane in the feedstock that is introduced to the reactor. In another embodiment, the molar flow rate of the trichlorosilane in the product mixture is greater than the molar flow rate of the trichlorosilane in the feedstock that is introduced to the reactor. In various additional embodiments, any two or more of which embodiments are, or may be, combined in order to provide a particular embodiment of the present process: the trichlorosilane is introduced into the reactor as a gas phase; the hydrogen chloride is introduced into the reactor as a gas phase; the trichlorosilane and hydrogen chloride are introduced into the reactor as an admixture; the admixture also comprises hydrogen (H₂); the admixture also comprises dichlorosilane (DCS); the admixture also comprises silicon tetrachloride; the admixture comprises each of silicon tetrachloride, trichlorosilane, dichlorosilane, hydrogen chloride and hydrogen.

In another embodiment, provided herein is a process comprising combining silicon tetrachloride (STC), hydrogen chloride, and metallurgical grade silicon in a reactor under conditions to provide a product mixture comprising trichlorosilane. The reaction conditions may be a temperature of 250-400° C. and a pressure of 2-33 barg, for a time sufficient to convert metallurgical grade silicon to trichlorosilane. In various embodiments, any two or more of which embodiments are, or may be, combined in order to provide a particular embodiment of the present process: the silicon tetrachloride is introduced into the reactor as a gas phase; the hydrogen chloride is introduced into the reactor as a gas phase; the silicon tetrachloride and hydrogen chloride are introduced into the reactor as an admixture; the admixture also comprises hydrogen (H₂); the admixture also comprises dichlorosilane (DCS); the admixture also comprises trichlorosilane; the admixture comprises each of silicon tetrachloride, trichlorosilane, dichlorosilane, hydrogen chloride and hydrogen.

In yet another embodiment, provided herein is a process comprising combining hydrogen, hydrogen chloride, and metallurgical grade silicon in a reactor under conditions to provide a product mixture comprising trichlorosilane. The reaction conditions may be a temperature of 250-400° C. and a pressure of 2-33 barg, for a time sufficient to convert metallurgical grade silicon to trichlorosilane. In various embodiments, any two or more of which embodiments are, or may be, combined in order to provide a particular embodiment of the present process: the hydrogen is introduced into the reactor as a gas phase; the hydrogen chloride is introduced into the reactor as a gas phase; the hydrogen and hydrogen chloride are introduced into the reactor as an admixture; the admixture also comprises silicon tetrachloride (STC); the admixture also comprises dichlorosilane (DCS); the admixture also comprises trichlorosilane (TCS); the admixture comprises each of silicon tetrachloride, trichlorosilane, dichlorosilane, hydrogen chloride and hydrogen.

In each of the afore-listed embodiments, the HCl and M3 may come, at least in part, from an STC converter. For example, the present disclosure provides a process comprising a) introducing silicon tetrachloride and hydrogen to an STC converter and recovering an off-gas comprising hydrogen chloride and M3; and b) introducing the off-gas and metallurgical grade silicon to a chlorination reactor under reactor operating conditions comprising a temperature of 250-400° C. and a pressure of 2-33 barg, for a time sufficient to convert metallurgical grade silicon to an exit gas comprising trichlorosilane. In this process, any one or two or more of the following criteria may be used to further characterize the process: the silicon tetrachloride and hydrogen are combined in the STC converter at a temperature of 300-700° C. and a pressure of 3-15 barg for a time sufficient to generate the off-gas; the silicon tetrachloride and hydrogen are combined in the STC converter in the presence of a packed bed comprising metal silicide catalyst and the STC converter operates at an operating temperature of less than 800° C.; the STC converter operates with a hold up time which is less than a hold up time needed to achieve thermal equilibrium between the STC and TCS in off-gas; a diluent feed comprising hydrogen chloride and less than 5 mol % silicon tetrachloride is introduced into the STC converter along with the silicon tetrachloride and hydrogen; the off gas from the STC converter is brought, as needed, to a temperature at least 30° C. below the operating temperature of the chlorinator reactor, prior to the off-gas being introduced to the chlorinator reactor; the chlorinator reactor is constructed from materials comprising carbon steel; an aliquot of the exit gas from the chlorinator reactor is characterized as having a total number of moles of components, and hydrogen chloride constitutes less than 5 mol % of the total number of moles of the components.

In one embodiment, the invention may be viewed as the hybridization of direction chlorination and STC hydrochlorination. In one modality this hybridized technology makes possible the direct addition of STC converter off-gas to a chlorination reactor, without the intermediate separation of STC converter by-product gases into their singular, separate components, thereby disintermediating current industrial practice. Specifically, this eliminates the requirement for a vent gas recovery system for the vent gas from the STC converter. Such direct addition is made possible by the unexpected determination that, contrary to current practice, TCS, STC, and/or hydrogen when fed to a chlorination reactor, operated under conditions of the present invention, are beneficial and result in optimal performance of the combined STC conversion and HCl chlorination process.

TCS in the feed, when optionally combined with STC in the feed to the chlorination reactor according to the teachings of one aspect of this invention, does not result in increased conversion of metallurgic silicon to STC as may be expected; rather, a greater percentage of the metallurgic silicon may be converted to TCS. Further, the presence of hydrogen in the feed to the chlorination reactor has no deleterious effect on the operation of either the chlorination reactor or a hydrogen/TCS-STC separation system downstream of the chlorination reactor, when, in accord with the present invention, that process stream comprising hydrogen gas is recycled to the STC converter system. Recycle of hydrogen in this manner, directly to the STC converter, eliminates the requirement for the separate hydrogen recycle loop, around the chlorination reactor, required in current hydrochlorination reactor designs.

Thus, according to still another embodiment, the present invention provides a two stage process. The first stage is a relatively low-temperature, catalytic, non-equilibrium controlled STC converter. The second stage may operate essentially the same as the standard direct chlorination reactor, however running with a radically different feedstock. In practice, these two reactors could be two separate reactors connected by gas piping, or close coupled into one reactor shell with two separate reaction zones. For example, in order to prepare an admixture that comprises silicon tetrachloride, trichlorosilane, dichlorosilane, hydrogen chloride and hydrogen, a first stage reactor may be established wherein silicon tetrachloride (STC) is reacted with hydrogen (H₂) gas. This first stage reactor may be operated in a continuous manner. The STC and hydrogen may be combined at a temperature of 300-700° C. and a pressure of 2-33 barg, or 3-7 barg, for a time sufficient to generate the admixture comprising trichlorosilane and optionally one or more of dichlorosilane, hydrogen chloride, hydrogen and STC. Optionally, the first stage reactor may contain a packed bed of metal silicide catalyst which catalyzes the reaction between STC and hydrogen, where this first stage reactor is not operated under equilibrium conditions, i.e., it is operated under non-equilibrium conditions. HCl may be included as a component to the feedstock of the 1st stage reactor.

In still another embodiment, the invention provides a sequential process for producing trichlorosilane, where the process comprises a first step and a second step, the first step comprising combining starting materials comprising silicon tetrachloride and hydrogen at a first temperature and a first pressure in a reactor to provide an intermediate mixture comprising trichlorosilane and hydrogen chloride, the second step comprising combining the intermediate mixture with metallurgical grade silicon at a second temperature and a second pressure, to provide a product mixture comprising trichlorosilane. In optional embodiments, the first temperature is about 350° C., or one or more temperatures within the range of 325-425° C., the first temperature is one or more temperatures within the range of 300-600° C.; the second temperature is less than the first temperature; the second temperature is one or a range of temperatures that is or are less than the first temperature which is also one or a range of temperatures, the second temperature is about 300° C., the second temperature is one or more temperatures in the range of 275-325° C., the second temperature is one or more temperatures in the range of 250-400° C. The first pressure may be less than 33 barg, typically less than 20 barg, and typically in the range of 3 barg to 10 barg. Independently, the second pressure may be less than 33 barg, typically less than 20 barg, and typically in the range of 3 barg to 10 barg.

In various additional embodiments, any of the processes identified above or herein may be further characterized by one or more of the following conditions which apply to the reactor wherein trichlorosilane (and/or silicon tetrachloride and/or hydrogen), hydrogen chloride and metallurgical grade silicon are reacted to convert metallurgical grade silicon to an exit gas comprising trichlorosilane: the admixture fed into the reactor, or generated from a first stage reactor and then fed into the reactor, is combined with a diluent feed comprising hydrogen chloride, where the diluent feed may optionally include less than 5 mol % silicon tetrachloride; the reactor is a fluidized bed reactor; the reactor comprises a dip tube for introducing metallurgical grade silicon; the reactor is operated in a continuous manner, where reactants are continuously entering the reactor, and products are continuously exiting the reactor; the reactor optionally comprises a cooling element which conducts heat away from an internal portion of the reactor where metallurgical grade silicon is converted to chlorosilane; the reactor is constructed from materials comprising carbon steel; the trichlorosilane (and/or silicon tetrachloride and/or hydrogen) and hydrogen chloride are introduced into a fluidized bed comprising metallurgical grade silicon; an aliquot of the exit gas comprises a total number of moles of components, and hydrogen chloride constitutes less than 5 mol % of the total number of moles of components.

The details of one or more of these embodiments, and other embodiment of the invention, are set forth in the description below. The features illustrated or described in connection with one exemplary embodiment may be combined with the features of other embodiments. Other features, objects and advantages will be apparent from the description, the drawings, and the claims. In addition, the disclosures of all patents and patent applications referenced herein are incorporated by reference in their entirety.

### BRIEF DESCRIPTION OF THE DRAWINGS

Features of the invention, its nature and various advantages, will be apparent from the accompanying drawings and the following detailed description of various embodiments.

FIG. 1A provides a schematic view of a process and system according to the present disclosure that utilizes a cooling coil for temperature control in a chlorination reactor.

FIG. 1B provides a schematic view of a process and system according to the present disclosure that omits a cooling coil for temperature control in a chlorination reactor.

FIG. 2 provides a schematic view of a process and system according the present disclosure that combines a chlorination reactor with an STC converter, with optional system to provide hydrogen and STC to the STC converter.

### DETAILED DESCRIPTION OF THE INVENTION

In one aspect, the invention provides a process whereby feedstock materials including hydrogen chloride (HCl) as a first material (M1) and metallurgical grade silicon (MGSi) as a second material (M2) are introduced into a reactor along with at least one other gas phase material (i.e., a third material (M3)) selected from hydrogen gas (H₂), trichlorosilane (TCS), dichlorosilane (DCS) and silicon tetrachloride (STC). These three materials (M1, M2 and M3) are the feedstock for the process of the present invention, although additional materials such as those identified below may also be part of the feedstock.

The inclusion of M3 in the feedstock mixture is advantageous for at least the following reasons. First, it should be realized that in the typical direct chlorination reaction, the MGSi is present in large excess, and thus the HCl gas that enters the chlorination reactor is essentially completely consumed and substantially all of the chloride is converted to TCS. Thus, for the three moles of HCl that enter the reactor, approximately one mole of TCS and one mole of H₂ are generated in the gas phase. The amount of gaseous material, on a molar basis, that is present within the reactor is thus reduced along the fluidized reactor bed in going from the entrance to the exit of the reactor, where that reduction is a factor ⅓rd (3 moles of gas phase HCl ultimately yield 2 moles of gas phase product (1 mole of TCS and 1 mole of H₂)). The presence of M3 in the feedstock ameliorates that percent reduction in gas content. For example, if the feedstock consists of one mole of M3 and 3 moles of HCl along with a large molar excess of MGSi, the product(s) will be 1 mole of TCS, one mole of hydrogen (H₂), and assuming the M3 is unreacted, 1 mole of M3. In this scenario, four moles of gas enter the reactor, and three moles of gas exit the reactor, so that the change in the amount of gaseous material along the course of the fluidized bed of the reactor, on a molar basis, is a reduction of only ¼th, vs. a reduction of ⅓rd if the M3 would not be present. By comparing these two examples, it is clear that the number of moles of gas leaving the reactor is the second case is 50% greater than in the first case which proportionately increases fluidization in the second case all else kept equal. The significance of this result is improved reactor performance due to improved heat transfer.

Maintaining the moles of gas in the reactor at a near constant level, or at least ameliorating the reduction in the moles of gas during the course of the direct chlorination reaction, is beneficial. One benefit is that there is more gas phase molecules present to conduct heat. To appreciate the importance of this fact, one needs to appreciate that the conversion of HCl to TCS in a direct chlorination reaction is a highly exothermic process. The heat that is generated in this exothermic reaction is initially generated when the HCl reacts with the particles of MGSi that form the fluidized bed. Thus, the thermal energy is initially generated at the surface of the MGSi particles, causing the surface of the particles to be at a much higher temperature (ca. 700° C.) than the bulk temperature of the reactor (ca. 300° C.). This high temperature at the particle surface is disadvantageous because it causes/allows more side reactions to occur at the surface, e.g., STC formation. In order to reduce this problem, it is desirable to rapidly disseminate the heat from the particle surface. Such heat dissemination is achieved according to the present invention by ameliorating the percent reduction in the moles of gas present during the course of the reaction, and even more so by keeping the relative number of moles greater, for a given TCS production rate, than that in direct chlorination as currently practiced. As more moles of gas are present at any one time, there is more opportunity for that gas to carry away the thermal energy generated at the surface of the MGSi particles. In addition, the gas absorbs and is able to transport thermal energy to the side walls or other locations (e.g., cooling coils) of the reactor, which can serve to draw away heat.

A second advantage of maintaining the moles of gas within the reactor at a higher level is that the operation of the fluidized bed is maintained or enhanced. A fluidized bed requires a certain level of gas flow, and as the moles of gas in the reactor are reduced during the conversion of starting materials to products, according to current practice, that causes the fluidized bed to become less fluid, and thus less functional. For instance, the MGSi particles may agglomerate at high temperature and insufficient fluidization, thus hurting the performance of the fluidized bed. The inclusion of M3 in the feedstock, particularly M3 that does not undergo any significant reaction that reduces the number of moles of M3 present in the reactor, aids in maintaining the function of the fluidized bed in a direct chlorination reaction.

The selection of M3 is based on several factors. First, M3 is preferably inert, and more preferably, if M3 does undergo any chemical reaction, it is preferred that M3 does not decompose to form products having fewer moles of product than moles of starting material. Second, M3 preferably does not add significant impurities to the product stream. Based on this consideration, while an inert gas such as argon or nitrogen may be used as M3, such an inert gas adds a new component to the reactant/product mixture, which potentially must be removed at some point, adding undesirable complexity and cost to the process. Taking this point into consideration, TCS is an ideal choice for M3, since TCS is the desired product of the direct chlorination reaction. Another product of the direct chlorination reaction is hydrogen, and thus another good choice for M3 is hydrogen (H₂), since that is already a component of the product mixture from the direct chlorination reaction. STC is also a good choice for M3, since STC is essentially inert, and is a typical by-product of the direct chlorination reaction as operated under condition of the present invention. Dichlorosilane (DCS) may be used as the third material. In various embodiments of the invention as described herein, M3 may be TCS, or may be hydrogen gas, or may be STC, or may be DCS, or may be a combination of two or more of TCS, hydrogen gas, DCS and STC, e.g., M3 may be TCS in combination with hydrogen gas and STC.

Without intending to be bound by the theory, the following is offered to help explain the process of the present invention and the advantages thereof. As MGSi enters into the reaction vessel, it quickly mixes into the hot bed of the fluidized bed reactor (FBR), going from ambient temperature to about 300° C. in a second, where the surface of the particles heat up first. The oxide layer of the MGSi particle is quickly reacted away by the HCl, which occurs in a few seconds. Thereafter, the remaining MGSi surface reacts with the HCl, catalyzed by the presence of a Lewis acid (a.k.a. metal chlorides, like FeCl3) which in a preferred embodiment is present within the reactor. Other suitable Lewis acids are CuCl2 and ZnCl2. The overall chemistry occurring thus far in the process is summarized as follows:

MGSi+HCl→SiCl+½H₂ (which rapidly reacts) (1)

SiCl+HCl→SiCl₂+½H₂ (2)

MgSi+2HCl→SiCl₂+H₂ (1+2)

Silicon dichloride is a free radical that is stable at temperatures between about 300° C. and 800° C., particular in an HCl environment with Lewis acids. Silicon dichloride may preferably react with HCl to produce TCS, however, to a somewhat lesser (but finite) extent, the chain reaction continues with SiCl₂+HCl→SiCl₃+½H₂, when the bulk gas temperature is in the range of 300-450° C. These are exothermic reactions, and the heat is so intense that the particle surfaces can reach 1000° C. or higher if not adequately cooled off by the surrounding bulk gas. For fluidization ratios less than about 4-5 times Umf (incipient/minimum fluidization velocity), the predicted heat transfer coefficient for particle-to-bulk-gas heat exchange is significantly lower than for bulk-gas-to-coil heat transfer. Low relative fluidization is the root cause of forming agglomerates from the MGSi and having high interstitial gas temperatures (i.e., local-gas in close proximity to the MGSi particle surface), which can result in excessive, unwanted STC formation. As relative fluidization increases, both forms of heat transfer increase, but the relative change is such that particle-to-bulk-gas heat transfer becomes less controlling of the interstitial gas temperature. At Umf's over 6-8, the agglomeration phenomena has virtually disappeared macroscopically, i.e., while some agglomeration may still occur locally, but the attrition of chemical reaction holds it in check, so there is a net reduction of MGSi particle size.

The SiCl₃ radical may react with HCl to form STC under influence of Lewis acid catalysis, as shown in the following formula.

SiCl₃+HCl→SiCl₄+½H₂

In turn, TCS and STC approach equilibrium in a fluidized reactor as shown in the following formula.

TCS+HCl<=>STC+H₂

This reaction is shown as an equilibrium reaction, but it should be recognized as the main kinetic step of the hydrochlorination process, which can be affected both locally and “globally”. That is to say that the TCS/STC reaction is a complex function of local gas temperature within the fluidized reactor (i.e., localized “hot spots”) and average temperature in the reactor (e.g., reactor outlet temperature). Localized hot spots can generate excessive amounts of STC, thus increasing the average amount of STC which would otherwise be formed in the reactor solely as a result of that equilibrium made manifest at average reactor temperature. This phenomenon is explained further below. The TCS/STC reaction is very temperature sensitive. Very little reaction occurs at <250° C., regardless of the level of catalyst. But as temperature rises, so does both the equilibrium and the kinetics. Thus, the ratio of TCS/STC leaving the chlorination reactor is a complex function of reaction rate kinetics and thermodynamic equilibrium. At 300° C., the ratio is 85/15 by weight TCS/STC, however at 400° C. the ratio flips to 15/85—which is highly undesirable. Accordingly, it is preferred to operate the process of the present invention at a temperature of 400° C. or less, or a temperature of 375° C. or less, or a temperature of 350° C. or less, where the lower end of the temperature range is greater than 250° C., or greater than 275° C., or greater than 300° C. For example, 250-400° C. or 250-350° C. Accordingly, the process of the present disclosure may minimize the presence of local hot spots within the reactor and particularly within the fluidized bed, by including M3 within the feedstock delivered to the reactor. Advantageously, the present process removes heat from the particle surface (where the reaction takes place) much better, due to the higher fluidization (more turbulent, hence better heat transfer). An additional advantage of using STC or TCS as M3 is that these two materials have rather high heat capacities, and thus are able to remove heat relatively efficiently. Since the process of the present invention removes heat more quickly, there is a reduced number of higher temperature zones within the reactor, with their concomitant reduced tendency to produce excessive amounts of undesirable STC. Hence, the present invention enhances the formation of TCS.

When both STC and H₂ are included as feedstock materials, the higher hydrogen plus STC flow will tend to increase the size of the reactor (for a given hold up time to complete the reaction). However, due to the relatively low temperature of the chlorination reaction (only 300° C. compared to 450° C. to 500° C. for STC hydrochlorination which also introduces STC into a reactor), the present process can increase the system pressure—thus reducing the size of the reactor required for a given hold up time, without need to resort to highly expensive materials of construction (e.g., to Incoloy® 800H). In one embodiment, the reactor used for the process of the invention is prepared from carbon steel (rather than, e.g., Incoloy® 800H) which will bring the reactor cost down by an order of magnitude.

The process of the present invention may operate at 50 PSIG (current industry standard for direct chlorination), or at higher pressures, such as 100 PSIG, 200 PSIG, 300 PSIG, 400 PSIG, and even as high as 500 PSIG. At these higher pressures, there will be a reduction in the gas volumetric rate (but at the same higher mole ratio of hydrogen in the feed to the direct chlorination reactor) thus reducing the size of the reactor required for a given desired hold up time, but due to the higher pressure, the gas inside the reactor will have a much higher heat capacity, and hence will retain the benefit of significantly improved heat transfer out of the metallurgic silicon particles on whose surface the reaction is primarily occurring, with concomitant reduction in the reaction zone temperature and resultant improvement in TCS/STC ratio in reaction product.

The feedstock materials may be introduced separately to the reactor, or they may be introduced as an admixture. When the materials are introduced separately, then there are at least three unique conduits leading into the reactor, one conduit for each of the HCl, MGSi and M3. In one embodiment, an admixture including at least HCl and M3 is introduced via a first conduit, and MGSi is introduced to the reactor via a second conduit.

The relative amounts of HCl and M3 in the feedstock can be characterized in terms of molar percent, where the sum of the moles of M3 and HCl is the denominator, and the moles of M3 or the moles of HCl is the numerator, and where this ratio is multiplied by 100 to provide a molar percent. For example, the feedstock may contain 50 moles of M3 and 50 moles of HCl, which provides a feedstock having a 50% HCl molar percent and a 50% M3 molar percent. In various embodiments the feedstock is an admixture including M3 and HCl, where the admixture contains a molar percent of HCl that is equal to the molar percent of M3, or the admixture contains a molar percent of HCl that is greater than the molar percent of M3, or the admixture contains a molar percent of HCl that is equal to or greater than the molar percent of M3. For example, in various embodiments the admixture may be 50% HCl and 50% M3; 50-60% HCl and 50-40% M3; 50-75% HCl and 50-25% M3; 50-90% HCl and 50-10% M3; 60-80% HCl and 40-20% M3; or 60-90% HCl and 40-10% M3. Alternatively, the amount of M3 and HCl in the feedstock may be characterized by M3:HCl molar ratio. For instance, the molar ratio of M3 to HCl in the feedstock may range between 20:1 to 1:20, or between 20:1 to 1:1. In these and other embodiments of the present invention, M3 represents TCS, DCS, STC or hydrogen, where M3 may optionally be in combination with one or more other materials selected from TCS, DCS, STC or hydrogen. When the admixture contains HCl and two or more of TCS, STC, DCS and hydrogen, then in a various optional embodiments the HCl constitutes less than 60 mol %, or less than 50 mol %, or less than 40 mol %, or less than 30 mol % or less than 20 mol % or less than 10 mol % of these listed components.

The identity and relative amounts of the various materials present in the feedstock may be determined by obtaining an aliquot of the feedstock, i.e., a sample of a homogeneous mixture of the feedstock, and then subjecting that aliquot to an appropriate quantitative and qualitative analysis, e.g., mass spectrometry. When the feedstock materials are introduced via separate conduits, then a measure of the flow rate through the conduit, in addition to the temperature and pressure of the content of the conduit, can provide a measure of the quantity of that material that is entering the reactor in a unit amount of time, and this analysis can be repeated for each conduit.

When M3 is TCS, the feedstock may contain materials in addition to TCS, HCl and MGSi. In one embodiment, the feedstock includes hydrogen, i.e., H₂. For example, the feedstock may include an admixture that is, or includes, TCS, HCl and hydrogen, where this admixture enters the reactor via a first conduit, and in addition the feedstock includes MGSi which is introduced into the reactor via a second conduit. In another embodiment, the feedstock includes silicon tetrachloride (STC). For example, the feedstock may include an admixture that is, or includes, TCS, HCl and STC, where this admixture enters the reactor via a first conduit, and in addition the feedstock includes MGSi which is introduced into the reactor via a second conduit. In yet another embodiment, the feedstock includes both hydrogen and STC. For example, the feedstock may include an admixture that is, or includes, TCS, HCl, hydrogen and STC, where this admixture enters the reactor via a first conduit, and in addition the feedstock includes MGSi which is introduced into the reactor via a second conduit.

When M3 is STC, the feedstock may contain materials in addition to STC, HCl and MGSi. In one embodiment, the feedstock includes hydrogen, i.e., H₂. For example, the feedstock may include an admixture that is, or includes, STC, HCl and hydrogen, where this admixture enters the reactor via a first conduit, and in addition the feedstock includes MGSi which is introduced into the reactor via a second conduit. In another embodiment, the feedstock includes trichlorosilane (TCS). For example, the feedstock may include an admixture that is, or includes, STC, HCl and TCS, where this admixture enters the reactor via a first conduit, and in addition the feedstock includes MGSi which is introduced into the reactor via a second conduit. In yet another embodiment, the feedstock includes both hydrogen and TCS. For example, the feedstock may include an admixture that is, or includes, TCS, HCl, hydrogen and STC, where this admixture enters the reactor via a first conduit, and in addition the feedstock includes MGSi which is introduced into the reactor via a second conduit.

When M3 is hydrogen, the feedstock may contain materials in addition to hydrogen, HCl and MGSi. In one embodiment, the feedstock includes STC. For example, the feedstock may include an admixture that is, or includes, hydrogen, HCl and STC, where this admixture enters the reactor via a first conduit, and in addition the feedstock includes MGSi which is introduced into the reactor via a second conduit. In another embodiment, the feedstock includes trichlorosilane (TCS). For example, the feedstock may include an admixture that is, or includes, hydrogen, HCl and TCS, where this admixture enters the reactor via a first conduit, and in addition the feedstock includes MGSi which is introduced into the reactor via a second conduit. In yet another embodiment, the feedstock includes both TCS and STC (in addition to hydrogen as M3). For example, the feedstock may include an admixture that is, or includes, TCS, HCl, hydrogen and STC, where this admixture enters the reactor via a first conduit, and in addition the feedstock includes MGSi which is introduced into the reactor via a second conduit.

The feedstock is introduced into the reactor via one or more conduits. Within the reactor, the feedstock will undergo chemical reaction so as to provide a product mixture. The product mixture will exit the reactor via an exit conduit. Typically, the reactor will have a single exit conduit; however, the reactor may have two or more exit conduits. The reactor is maintained at an elevated temperature, i.e., a temperature above ambient temperature, as described in more detail elsewhere herein. At such an elevated temperature, the product mixture that exits the reactor via the exit conduit will be in the form of a gas or vapor. Thus, the product mixture that exits the reactor via the exit conduit may be referred to herein for convenience as an exit gas.

The chlorination reactor may operate in a semi-batch or a continuous mode. In a semi-batch mode, the metallurgic silicon feedstock is introduced into the reactor and maintained therein for a desired period of time, while an admixture comprising HCl is fed to the reactor, and gaseous reaction products are continuously withdrawn from the reactor. At the end of the desired period of time, the residual metallurgic silicon feedstock is withdrawn from the reactor, and a fresh metallurgic silicon feedstock is introduced into the reactor. Typically, the temperature and pressure within the reactor, when operated in a batch mode, will undergo significant fluctuation as the metallurgic silicon material is introduced and then withdrawn from the reactor. In a continuous mode, an admixture comprising HCl and metallurgic silicon is continuously fed to the reactor, and gaseous reaction products are continuously withdrawn from the reactor. In a continuous mode operation, the reactor is constantly maintained within a desired temperature and pressure range. In all of the aspects and embodiments of the processes disclosed herein, the chlorination reactor may be operated in a continuous mode.

The reactor into which the feedstock is introduced is maintained under conditions such that some or all of the MGSi is converted to a chlorosilane. The chlorosilane may be a monochlorosilane (H₃SiCl), a dichlorosilane (H₂SiCl₂), a trichlorosilane (HSiCl₃), a tetrachlorosilane (SiCl₄), or a mixture of any two or more of the aforementioned chlorosilanes. The exit gas preferably contains TCS and STC as the majority of the chlorosilane species, where in various embodiments the sum of the TCS and STC constitute at least 60%, or at least 70%, or at least 80%, or at least 90%, or at least 95% of the chlorosilane species in the exit gas, as measured on a molar basis. The relative amounts of TCS and STC in the exit gas may vary widely, depending to a large extent on the amount of TCS and STC present in the feedstock. Relative to the feedstock, the exit gas preferably contains a greater proportion of TCS, e.g., if the feedstock contains 30 mol % of TCS based on the total moles of chlorosilane, then the exit gas will contain greater than 30 mol % of TCS based on the total moles of chlorosilane in the exit gas.

In one embodiment, an excess of MGSi is used in the feedstock. In fact, metallurgic silicon “feedstock” may be viewed as a charge of silicon to the reactor, which charge is periodically replenished so that the relative amount of metallurgic silicon is in gross stoichiometric excess at any given point in time. The MGSi may be present in such an amount that all, or nearly all, of the chloride component of the hydrogen chloride present in the feedstock is converted to one or more chlorosilanes, where the chlorosilane is preferably TCS. In this embodiment, the exit gas will contain an increase in the amount of TCS (relative to the amount of TCS present in the feedstock) equal to about ⅓ of the number of moles of HCl present in the feedstock, since three moles of HCl are converted to about 1 mole of TCS within the reactor.

The feedstock materials are fed into the reactor via one or more conduits and the product mixture exits the reactor via one or more conduits. Between being fed into the reactor and exiting the reactor, and during the time that the materials are present within the reactor, the feedstock will convert to a product mixture. That time period may vary depending on the feedstock material, as discussed elsewhere herein. In one embodiment, an admixture containing at least TCS (or other M3 option) and HCl is fed into the reactor via a first conduit, and MGSi is fed into the reactor via a second conduit. The second conduit may be a feeder dip tube that extends from the top, or near the top, of a vertically disposed reactor to a point at or near the bottom of the reactor. The MGSi may be fed into the reactor in molar excess relative to the amount of hydrogen chloride that is introduced into the reactor. In other words, at any one time, the moles of hydrogen chloride present in the reactor will be less than the number of moles of silicon contained within the MGSi that is present in the reactor.

In one embodiment, the MGSi is present within the reactor as part of a fluidized bed. Fluidized bed technology is well known in the art, and is advantageous in the present invention as a means of promoting high contact between solid forms of the feedstock materials (e.g., MGSi) and the gaseous forms of the feedstock materials (e.g., TCS and HCl may be in the gas phase within the reactor). In an exemplary fluidized bed arrangement, MGSi in a particulate form is fed by a feeder conduit into the bed, while a second conduit delivers TCS and HCl to the fluidized bed. Particularly when MGSi is present in the reactor in large stoichiometric excess compared to HCl, the MGSi may be omitted from consideration as a feedstock that enters the reactor.

As mentioned above, the reactor is operated at, i.e., maintained at, an elevated temperature. The process of the present disclosure avoids the need to use the very high elevated temperature that is typically called for in the well-known hydrochlorination process for making TCS. In hydrochlorination, STC and hydrogen are contacted with a fluidized bed of metallurgic silicon which has been heated to a temperature of about 500° C. at a pressure of around 33 barg, in order to produce TCS. The hydrochlorination process, while widely practiced commercially, suffers from relatively low conversion, only 20% to 25% STC conversion per pass, from relatively long reactor hold-up time resulting in relatively large sized reactors, and from the requirement for expensive materials of construction necessitated by high operating temperature and pressure. A further disadvantage is the high inherent safety hazard associated with such high temperature and high pressure operation. An advantage of the present process is that TCS may be produced from STC at much lower temperature and pressure. In the present process, the reactor is maintained at a temperature of less than 500° C., typically less than 400° C., and typically in the range of 250-350° C., and a pressure less than 33 barg, typically less than 20 barg, and typically in the range of 3 barg to 10 barg. This lower temperature and pressure provides many advantages compared to the hydrochlorination process, as discussed elsewhere herein.

As mentioned previously, the reaction of MGSi with HCl is highly exothermic. Therefore, in order to maintain the reactor temperature at a desired operating temperature, the heat of reaction must in some way be dissipated. Methods and systems to absorb heat by external cooling means are well known in the art, and may be used in the present process. For example, a cooling coil may be positioned within the reactor, and cooling fluid may be transported through the coil. The cooling fluid enters a portion of the cooling coil sited within the reactor at a temperature which is lower than the internal temperature of the reactor. The cooling fluid then absorbs heat from the walls of the cooling coil, thereby cooling those walls that are likewise in contact with the reactor contents. Heat from the reactor will then dissipate into the walls of the cooling coil, thereby absorbing heat from the reactor. As cooling fluid flows through the cooling coils, excess heat from the reactor is continuously being absorbed, thereby maintaining the operating temperature of the reactor at a desired value or within a desired range, even though the reactor is continuously generating heat due to the exotherm of the chlorination reaction. An alternative means to dissipate heat is to place a cooling jacket on the outside walls of the reactor. These and other external means to remove excess heat from a reactor are well known to the person skilled in the art and may be employed in the present process and systems.

In one embodiment, the present process provides for an alternative approach to maintaining the reactor at a desired operating temperature, i.e., an alternative to external cooling. This alternative approach will be referred to herein as internal cooling. In an internal cooling process, a gas phase cooling fluid is introduced into the reactor space occupied by the reactants, that is, in the same space as occupied by the MGSi and HCl. The cooling fluid is introduced at a lower temperature than the operating temperature of the reactor. The input conditions of the cooling fluid are selected such that the cooling fluid is able to absorb essentially all of, but not more than, the heat generated by the exothermic chlorination reaction.

In other words, the reaction may optionally be run under adiabatic or near-adiabatic conditions. An adiabatic process refers to any process occurring without gain or loss of heat within a system (i.e. during the process the system is thermodynamically isolated such that there is no heat transfer with the surroundings). This is the opposite of a diabatic process, where there is heat transfer. An adiabatic process can occur if the container of the system has thermally-insulated walls or the process happens in an extremely short time, so that there is no opportunity for significant heat exchange. In other words, a transformation of a thermodynamic system can be considered adiabatic when it is quick enough or so well insulated such that no significant heat is transferred between the system and the outside (e.g., to cooling coils containing a heat transfer medium). The process of the present disclosure can operate adiabatically when the reactor is suitably insulated, and the feedstocks are delivered at suitable temperature and composition.

The input conditions for the internal cooling fluid include the incoming temperature of the fluid, the content of the fluid, and the hold-up time of the fluid. As the temperature of the internal cooling fluid is lowered, it will absorb more heat from the reactor contents. It is undesirable for the reactor contents to become too cool, because if the temperature inside the reactor is too cool then the desired chlorination reaction either does not occur, or occurs more slowly than is desirable. In embodiments, the incoming temperature of the internal cooling fluid is at least 30° C., or 40° C., or 50° C., or 60° C., or 70° C., or 80° C., or 90° C., or 100° C., or 110° C., or 120° C., or 130° C., or 140° C., or 150° C., or 200° C. lower than the desired operating temperature of the reactor. The internal cooling fluid may be brought to a desired temperature by heating and or cooling methods known in the art for heating or cooling gases.

The content of the fluid will also need to be selected. The fluid may be a single chemical, or a mixture of chemicals. Exemplary components for the internal cooling fluid include STC, TCS, DCS, and hydrogen, where these components may be used alone or in any combination of 2 or 3 or all of the components. Some cooling fluid components require more heat to increase their temperature from a first to a second temperature (i.e. from T₁ to T₂) than do other cooling fluid components. This ability of a material to absorb heat may be measured by molar heat capacity. The molar heat capacity of gas phase STC is about 90 J/(mol K) while the molar heat capacity of gas phase hydrogen is about 29 J/(mol K). Accordingly, a mole of STC absorbs more heat as it warms from T₁ to T₂, than does a mole of hydrogen. As the cooling fluid is enriched in STC at the expense of hydrogen, all other factors being equal, the cooling fluid has a greater capacity to absorb heat and so the reactor contents are liable to cool below the desired minimum. Conversely, as the cooling fluid is enriched in hydrogen at the expense of STC, the cooling fluid cannot absorb as much heat, and is less effective. This effect can be counter-acted by using more of a cooling fluid having a lower molar heat capacity. However, using more cooling fluid requires a larger reactor to contain the larger amount of cooling fluid, which adds to the capital cost of the system. Another disadvantage of using more cooling fluid is that the reactants and products become diluted, which reduces the operating efficiency of the system.

In one embodiment, the internal cooling fluid is admixed with M1 (HCl) and M3, and then brought to a desired temperature, which is less than the operating temperature of the reactor, prior to the admixture entering the reactor. As mentioned above, exemplary internal cooling fluids may be any one or more of STC, TCS, DCS and hydrogen. Since M3 may also be selected from hydrogen gas (H₂), trichlorosilane (TCS), dichlorosilane (DCS) and silicon tetrachloride (STC), it can be seen that M3 and the internal cooling fluid may be one and the same. In other words, M3 can function as an internal cooling fluid, in the event that M3 is introduced into the reactor at a temperature less than the operating temperature of the reactor. In various embodiments, when M3 functions as an internal cooling fluid, the HCl and the M3/coolant may enter the reactor at a molar ratio of M3/coolant:HCl of 2:1 to 20:1, or 3:1 to 18:1, or 4:1 to 16:1, or other ratios as disclosed herein.

The system may optionally include a temperature control means, e.g., a cooling jacket or a heating coil surrounding the conduit, to control the temperature of the first product gas before it enters the 2nd stage reactor. The system may optionally include a temperature monitoring means, e.g., a thermocouple, to monitor the temperature within the 2nd stage reactor. The temperature monitoring means may be a component for feedback temperature control, so that when the temperature within the chlorination reactor exceeds a predetermined value, this state is detected by the temperature monitoring means and an electric signal is sent to the temperature control means that is in physical communication with the conduit so that cooling is applied to the conduit carrying the first product gas, thus lowering the temperature of the first product gas as it enters the chlorination reactor and consequently lowering the temperature within the chlorination reactor back to a temperature below the predetermined value. Likewise, the temperature monitoring means may sense that the temperature within the chlorination reactor is below a predetermined value, thus causing a signal to be sent to the temperature control means which causes the temperature control means to apply less cooling to the conduit carrying the first product gas. This feedback control of feed temperature to the chlorination reactor is one embodiment of the process and system of the present disclosure that may be used when the chlorinator reactor is operated in an adiabatic mode.

Accordingly, in one aspect, the present disclosure provides a process comprising combining hydrogen chloride, metallurgical grade silicon and a third material (M3) selected from silicon tetrachloride, trichlorosilane, dichlorosilane, and hydrogen, in a reactor, under reaction conditions comprising a temperature of 250-400° C. and a pressure of 2-33 barg, for a time sufficient to convert metallurgical grade silicon to an exit gas comprising trichlorosilane, where the process is operated in an adiabatic manner. When adiabatic operating conditions are desired, the process may further include feedback control of feed temperature to the reactor. Feedback control comprises monitoring the temperature within the reactor to determine an operating temperature, comparing the operating temperature to a pre-selected operating temperature range, and either raising the temperature of M3 if the operating temperature is below the preselected range or lowering the temperature of M3 if the operating temperature is above the preselected range.

An advantage of the present process compared to direct chlorination is that product from the STC converter may be directly added to the chlorination reactor without need for an off-gas separation system (thereby significantly reducing capital and operating expenses). An advantage of the present process compared to hydrochlorination, which does not have an STC converter nor an STC converter off-gas system, is that the net conversion of STC to TCS is higher (e.g., as much as 40% net STC conversion) compared to only 20% to 25% in hydrochlorination, and further that the temperature and pressure are lower, resulting in a much safer, less costly reactor system.

In the event that the feedstock has an initial temperature which is equal to ambient temperature, then the feedstock is preferably heated to a temperature that provides the feedstock (HCl and M3) in the gas phase, somewhat near the temperature maintained within the reactor. In particular, when the feedstock includes an admixture including M3 and HCl, the admixture may be heated to a temperature of, for example, 250-350° C. before it is admitted to the reactor. Under this elevated temperature condition, the admixture may be in the gas phase, depending on the pressure maintained in the conduit. If the feedstock is introduced to the reactor via separate conduits, the conduits may be heated so as to raise the temperature of the feedstock materials to a temperature that is near to the temperature of the reactor, and under these elevated temperature conditions the feedstock material may be in the gas phase, depending on the pressure maintained in the conduit. Thus, in various embodiments, the M3 is introduced into the reactor as a gas; the HCl is introduced into the reactor as a gas; an admixture including M3 and HCl is introduced into the reactor as a gas, an admixture including M3, HCl and hydrogen is introduced into the reactor as a gas; an admixture including M3, HCl and STC is introduced into the reactor as a gas; an admixture including M3, HCl, STC and hydrogen is introduced into the reactor as a gas; metallurgic silicon is added as a solid.

The reactor is maintained at both an elevated temperature and an elevated pressure, relative to ambient conditions. Suitable elevated temperatures are described elsewhere herein. Suitable elevated pressures are greater than atmospheric pressure, and are identified herein with units of barg, i.e., units of bar (1 bar being defined as 10⁶ dyne/cm²) measured by a gauge which is zero-referenced against ambient air pressure. Thus, the barg pressure is equal to absolute pressure minus atmospheric pressure. In various embodiments, the reactor is maintained at an elevated pressure of less than 33 barg; less than 20 barg; less than 10 barg; less than 8 barg; less than 6 barg; less than 5 barg; at least 2 barg; at least 3 barg; at least 4 barg, and any combination thereof of an upper and lower limit as mentioned, for example between 2 and 5 barg. In one embodiment when relatively large amounts of hydrogen are used, it may be desirable to run under somewhat higher pressure so as to reduce the reactor size for a given HUT.

In one embodiment, the temperature and pressure within the reactor are selected so as to maintain at least some of the reactor contents in a gaseous state in view of the amount of feedstock material being fed into the reactor. In one embodiment, the temperature in the reactor is in the range of 200-400° C. and the pressure is in the range of less than 6 barg. In another embodiment, the temperature in the reactor is in the range of 250-350° C. and the pressure is in the range of 2-5 barg.

In one embodiment, a first conduit delivers a feedstock gas stream to the reactor, a second conduit delivers a feedstock solid (particulate) stream to the reactor, and an exit conduit provides for egress of a product gas stream from the reactor. During this process, a chloride containing gas is delivered to the reactor with constituents including hydrogen chloride and TCS, and a chloride containing gas exits the reactor with constituents including of one or more chlorosilanes. The gaseous feedstock material will be present within the reactor for a reaction time, where this reaction time may be varied over a wide range of times, and may be selected so as to maximize the content of the desired chlorosilane(s) in the exit gas. In various embodiments, the reaction time is less than 100 seconds; less than 75 seconds; less than 50 seconds; less than 25 seconds; at least 1 second, at least 5 seconds; at least 10 second; at least 25 seconds; and each combination of maximum and minimum values as mentioned, for examples, the reaction time may be between 05 and 50 seconds; or between 50 and 100 seconds.

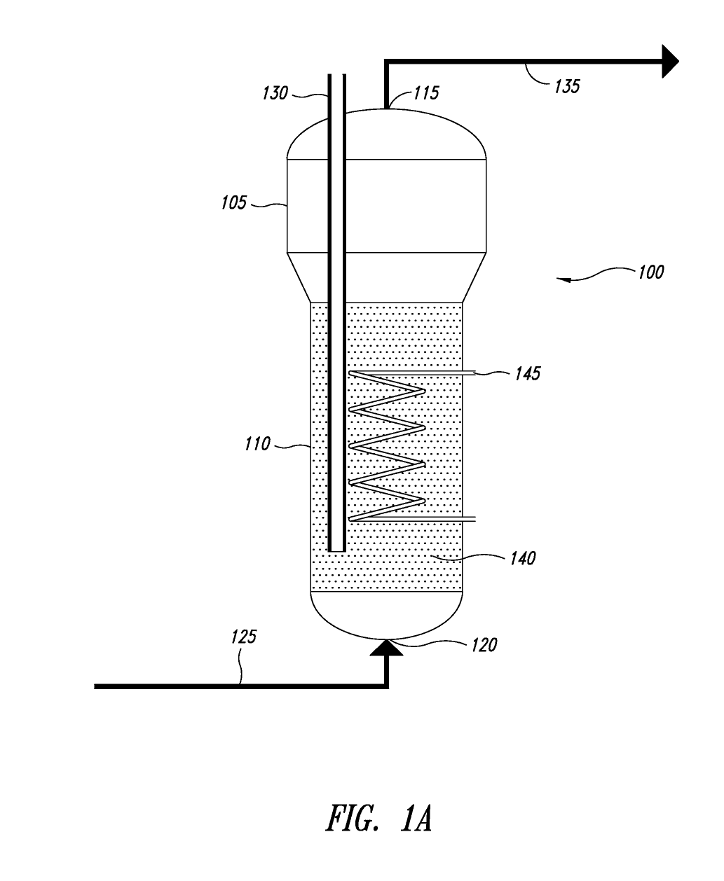

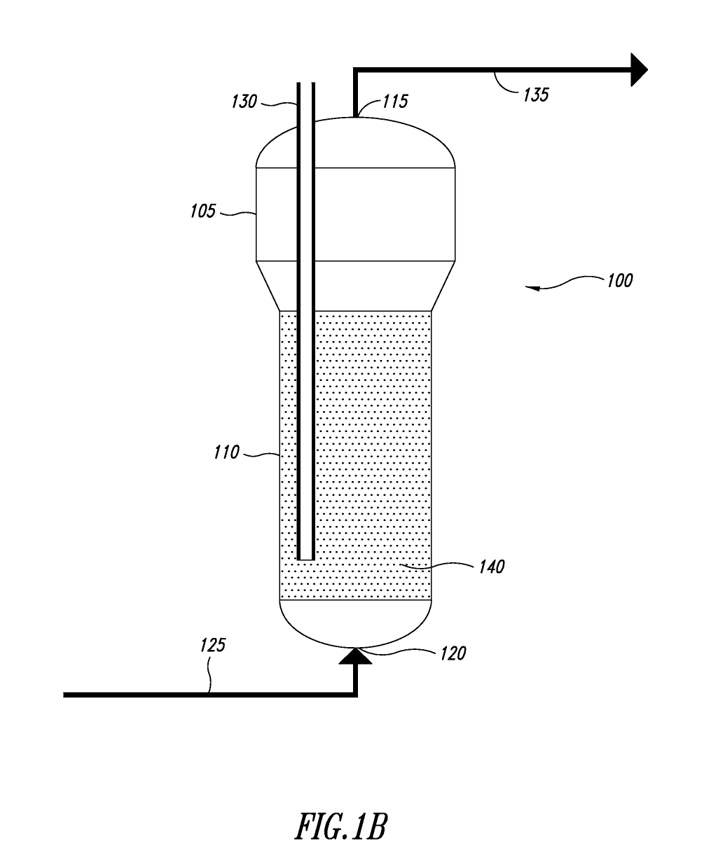

A suitable reactor for the process of the present invention is illustrated in FIGS. 1A and 1B. In FIGS. 1A and 1B, a reactor 100 is disposed in a vertical fashion. The reactor 100 is made from a sturdy material which can withstand elevated temperature, pressure and contact with corrosive materials. Such materials are well known in the art, and include carbon steel. The reactor may be generally cylindrical, as shown in FIGS. 1A and 1B, including an upper region 105, a lower region 110, a top 115 and a bottom 120. The upper region 105 and lower region 110 are adjacent to one another, as shown in FIGS. 1A and 1B. When the reactor 100 is generally cylindrical, each of the upper region 105 and lower region 110 will have a diameter. In one embodiment, the diameter of the upper region 105 is greater than the diameter of the lower region 110 to allow particle disengagement. When fluidized bed technology is employed in a vertically disposed reactor, the fluidized bed will be located in the lower region. Optionally, the reactor could be a cylinder for its whole length with an internal or external cyclone instead of a larger diameter calming zone.

The reactor 100 is attached to a first conduit 125, a second conduit 130, and an exit conduit 135. Both the first conduit 125 and the second conduit 130 may be used to introduce feedstock material to the reactor. For example, the first conduit 125 and the second conduit 130 may introduce feedstock material into a fluidized bed 140 that is present within the lower region 110 of the reactor, while in a preferred embodiment the conduits 125 and 130 introduce feedstock materials into a region of the fluidized bed 140 that is located half way down the lower region 110, or more than half way down the lower region 110. The first conduit 125 may be used to introduce a gas phase admixture of feedstock materials including M3 and HCl, while the second conduit 130 may be a feeder dip-tube that is useful for introducing particulate MGSi to the fluidized bed 140 within reactor 100. The exit conduit 135 is useful in allowing egress of the gaseous product mixture from the reactor 100, where the exit conduit may be in communication with the reactor 100 at the upper region 105 of the reactor, optionally at the top 115 of the reactor as shown in FIGS. 1A and 1B, or at some other location near the top 115 of the reactor 100. With the configuration of reactor 100 and conduits 125, 130 and 135 as shown in FIGS. 1A and 1B, feedstock materials enter a fluidized bed 140 near the bottom 120 of the lower region 110 of the reactor, and then undergo chemical reaction while moving upwards through the fluidized bed 140 to form a product mixture that enters into the second region 105, which acts as a solid de-entrainment zone, whereupon the product mixture exits the reactor via conduit 135. The conduits 125, 130 and 135 may be prepared from material that is suitable to withstand elevated temperature and pressure, as well as corrosive materials, where carbon steel is one such suitable material.

The reactor 100 may contain a temperature regulating means, exemplified as coil 145 in FIG. 1A. The temperature regulating means allows the temperature within the reactor 100 to be raised or lowered as desired by the operator. For example, when the temperature within the reactor 100 exceeds a desired value, a coolant may be pumped through the coil 145 in order to withdraw heat from the reactor. In such a situation, the temperature regulating means may be referred to as a cooling element. The reaction of HCl with MGSi is exothermic, and thus the temperature within the reactor may increase beyond a desired value when HCl reacts with MGSi to produce chlorosilane. The presence of a cooling element is thus beneficially employed in order to draw away the heat produced from this exothermic reaction, and maintain the reactor within a desired temperature range. In order to assist heat removal, an outer cooling jacket (not shown) may be placed around the reactor. Heat removal may be achieved through the presence of a series of vertical tubes that crowd the internal of the fluidized bed reactor, where these tubes should be resistant to MGSi-induced erosion, and should be resistant to chemical attack by HCl. A cooling coil, placed partway out along the radius of the reactor, at the nexus of the upward (inner) and downward (outer) paths of the churning FBR particle paths is a suitable means of cooling.

The presence of the coiling coil is optional, and in one embodiment the coiling coil is absent, where this embodiment is illustrated in FIG. 1B. In the event the reaction is operated under adiabatic or near adiabatic conditions, wherein the temperature of the HCl and M3 being introduced into the chlorination reactor is sufficiently lower than the operating temperature that the HCl and M3 absorb the heat generated by the exothermic chlorination reaction, then there is no need for a cooling coil.

Not shown in FIG. 1A or 1B is that the reactor 100, via one or more of conduits 125, 130, and 135, may be connected to one or more chemical storage vessels. These chemical storage vessels are usefully employed with the reactor 100 in order to, for example, store the products that are present in the exit gas, until such time as the products are needed, and/or to store feedstock material(s) until such time as they need to be introduced into the reactor 100. In addition, or alternatively, one or more of the conduits 125, 130 and 135 may be connected to one or more chemical reactors. For example, the conduit 125 may be connected to a chemical reactor that produces one or more of the feedstock materials, and/or the conduit 135 may be connected to a chemical reactor that utilizes the product mixture as a feedstock material. In addition, or alternatively, one or more of the conduits 125, 130 and 135 may be connected to a purification system. For example, conduit 135 may be connected to a purification system whereby one or more components of the product mixture is/are separated from one or more other components of the product mixture.

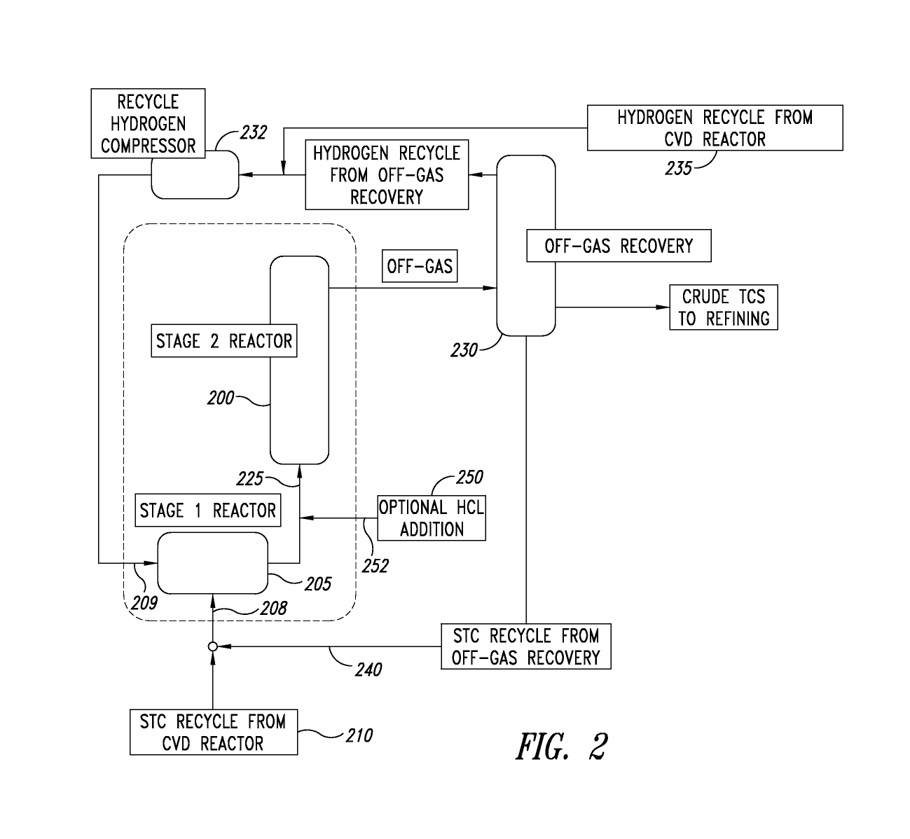

In one embodiment of the present process and system, the conduit 125 is connected to a first stage chemical reactor that produces a gaseous admixture which serves as part of the feedstock material for a second stage chemical reactor wherein the process as described herein (the reaction taking place in reactor 100) takes place. This embodiment is illustrated in FIG. 2, where reactor 100 is identified by 200, and conduit 125 is identified by 225. In FIG. 2, reactor 200 may or may not have a cooling coil and/or a cooling jacket. For example, the 1st stage chemical reactor 205 may be utilized in a process whereby silicon tetrachloride (STC) and hydrogen (H₂) gas are reacted together under suitable reaction conditions to produce an admixture of TCS and HCl. In one embodiment, the reactor 200 is connected via conduit 225 to a 1st stage chemical reactor (205) wherein STC and hydrogen are combined at a temperature and a pressure sufficient to generate an admixture that includes TCS, HCl, and optionally also includes STC and hydrogen, where this admixture leaves reactor 205, travels through conduit 225, and enters into reactor 200. Optionally, this gas mixture is not fractionated or purified as it travels from reactor 205 to reactor 200. The STC enters the 1st stage reactor via a conduit 208, while the hydrogen enters the 1st stage reactor via a conduit 209. Optionally, the STC and hydrogen may be combined and the admixture thereof enters the first stage reactor via a single conduit. HCl may optionally be added to 205 (not shown). The hydrogen and STC may come from reservoirs that contain each of the two material in purified form

Optionally, the STC and hydrogen for the 1st stage reactor may come from other systems in fluid communication with the 1st and 2nd stage reactors, where those optional systems are shown in FIG. 2 located outside the dashed line that encompasses the 1st and 2nd stage reactors. For example, the STC for the reactor 205 may be provided by the conduit 208 that may optionally connect to a CVD reactor 210 wherein the Siemen's process takes place. Alternatively, or additionally, the STC for the reactor 205 may come from any other suitable source, including off-gas from the 2nd stage reactor, as discussed below and shown in FIG. 2. The hydrogen for the reactor 205 may be provided by the conduit 209 that may optionally be in fluid communication with an off-gas recovery system 230 that is also in fluid communication with the 2nd stage reactor 200. In this optional embodiment, the hydrogen present in the off-gas from the 2nd stage (direct chlorination) reactor is purified in the off-gas recovery system 230, then optionally compressed with a recycle hydrogen compressor 232, and then delivered into the 1st stage (STC converter) reactor via conduit 209. Optionally, as shown in FIG. 2, some of the hydrogen for 1st stage reactor may come from the CVD reactor 235 in which the Siemen's process is conducted. The off-gas recovery system 230, in addition to providing purified hydrogen, may also provide purified STC that may be directed via conduit 240 into the 1st stage reactor, as shown in FIG. 2. Optionally, the hydrogen and STC for the 1st stage reactor may come from off gas from the Siemen's process. Optionally, the hydrogen and STC for the 1st stage reactor may come from off gas from the 2nd stage reactor. Optionally, the hydrogen and STC for the 1st stage reactor may come from off gas from the Siemen's process and/or as off gas from the 2nd stage reactor.

The temperature and pressure for the 1st stage reactor 205 may be, e.g., 300-500° C. and 3-15 barg, where the STC and hydrogen are maintained under these conditions for a time sufficient to generate an admixture that includes TCS and HCl. A packed bed of metal silicide may be present within the first stage chemical reactor, where the metal silicide catalyzes the generation of TCS and HCl from STC and hydrogen under the stated exemplary conditions of temperature and pressure. In a catalyst-free 1st stage reactor, the reactor may be operated at a higher temperature, e.g., 1100° C. to 1300° C., for a time sufficient to generate an admixture that includes TCS and HCl. As shown in FIG. 2, the process described herein that takes place in a direct chlorination reactor 200 may be operated in conjunction with a process as also described herein that takes place in the 1st stage STC converter chemical reactor. For purposes of energy conservation, heat interchange equipment may be utilized to exchange heat between the feeds and products of reactor 200, and to exchange heat between the feeds and products of the first stage reactor 205. Further, heat removed from exothermic reactor 200 may be used in conjunction with heat exchange equipment to provide heat to the endothermic reaction taking place in the first stage reactor 205.

In one embodiment, the conduit 225 is connected to, i.e., is in fluid communication with, a storage vessel 250 that contains HCl via an optional conduit 252. The HCl may be in pure form, that is, in greater than 95% purity, or greater than 99% purity, where the purity determination is based on the moles of all of the materials present in the storage vessel. The HCl may be in contact with STC, where in one embodiment the HCl is in admixture with STC but the concentration of STC is low, that is, less than 10 mol %, or less than 5 mol %, based on the total moles of HCl and STC in the storage vessel.

In one embodiment, the conduit 225 is connected to, i.e., is in fluid communication with, both a 1st stage chemical reactor 205, and a storage vessel 250 that contains HCl, as also described above. In this way, the concentration of HCl that enters the reactor 200 may be increased beyond the concentration of HCl that is present in the admixture generated from the 1st stage reactor 205. In one embodiment, the present process for converting metallurgical grade silicon to a gas comprising trichlorosilane includes preparing a feedstock from a first stage reactor 205 as described above, and delivering that feedstock via a first conduit 225 to a reactor 200, while in a related embodiment the admixture from the first stage reactor 205 is diluted with HCl from a storage vessel 250 containing HCl, to thereby form a feedstock admixture containing at least TCS and HCl, optionally also including STC, DCS, or hydrogen, or both STC, DCS, and hydrogen, where this feedstock admixture is contacted with metallurgical grade silicon in the second stage reactor 200.

As mentioned previously, the chlorination reactor 100 or 200 yields a product mixture contained within an exit gas. In one embodiment, the product mixture contains little or no HCl. For example, and based on the total moles of chloride-containing materials present in an aliquot of exit gas, less than 10% of those moles may be HCl, or less than 5%, or less than 2%, or less than 1%, or less than 0.5%. As another example, and based on the total moles of materials present in an aliquot of exit gas, less than 10% of those moles may be HCl, or less than 5%, or less than 2%, or less than 1%, or less than 0.5%. An exit gas having a lower content of HCl is encouraged to form when one or more of the following reaction conditions exist: MGSi is present in a molar excess within the reactor, the reaction time during which MGSi and HCl are contacted is increased, the temperature at which MGSi and HCl are in contact is increased, the pressure under which MGSi and HCl are contacted is increased.

As mentioned previously, one aspect of the present disclosure is a process that comprises a direct chlorination reaction whereby HCl and MGSi react in the presence of M3 to form TCS, where the M3 and/or HCl are produced in an STC converter. Thus, the present disclosure provides a process comprising (a) introducing silicon tetrachloride and hydrogen to an STC converter and recovering an off-gas comprising hydrogen chloride and M3; and (b) introducing the off-gas from the STC converter and metallurgical grade silicon (MGSi) to a chlorination reactor under reactor operating conditions comprising a temperature of 250-350° C. and a pressure of 2-33 barg for a time sufficient to convert MGSi to an exit gas comprising trichlorosilane. This aspect of the present disclosure effectively converts STC to TCS, with the addition of hydrogen and MGSi.

The STC converter may be operated in a conventional manner. STC converters are known in the art and are currently operated around the world in polysilicon manufacturing plants. These converters are also known by other names such as STC to TCS converter, STC to TCS hot converter, STC-to-TCS thermal converter and STC hydrogenation converter. By whatever name, they conventionally operate to convert STC and hydrogen to TCS and HCl at an operating temperature of about 1100° C. and an operating pressure of about 6 barg. These high temperatures are typically achieved using graphite heating elements located within the converter.

This high temperature in excess of 1100° C. for an STC converter is undesirable from both a capital cost and operational cost point of view. Energy costs money, and it requires more energy to maintain a converter at a higher temperature than at a lower temperature. Particularly when the temperature is very high, in excess of 1,000° C., the heat introduced into a converter will quickly escape into the ambient environment. To mitigate this temperature loss, thermal converters are well insulted, typically with blocks of graphite insulation placed around the inside of the converter's shell. However, in typical practice those insulation blocks quickly degrade and must be replaced every 3-6 months. Maintaining a high temperature is also challenging from an operational point of view. The graphite heating elements, for example, add carbon in the form of methyl chlorosilanes to the TCS product, where those methyl chlorosilanes are very difficult to separate from the TCS.

The operating temperature of the STC converter may be lowered by including a catalyst within the reactor. The catalyst may be a metal catalyst, such as a metal silicide. The metal silicide desirably exhibits one or more of the following properties: (a) it forms a stable silicide form, which will form an adduct with a silicon dichloride free radical; (b) it forms a silicide that exhibits multiple valence states (e.g., Ni₂Si or NiSi); and (c) the corresponding metal chloride form of the metal silicide has sufficiently low volatility that it does not vaporize away from the silicide form under reaction conditions (as would AlCl₃), or form a non-reactive liquid film (as would PbCl₂)). Exemplary metal silicide catalysts are chrome silicide, for example CrSi, CrSi₂, Cr₃Si or Cr₅Si₃; nickel silicide, for example NiSi, Ni₂Si, NiSi₂ and Ni₃Si; iron silicide, for example, FeSi and β-FeSi₂; and copper silicide. Other metal silicide catalysts may be used as well. The catalyst may be a mixture of metal silicides, for example, chrome silicide in combination with nickel silicide.

The metal catalyst may be present within the STC converter at high surface area. One way to achieve a high surface area of metal catalyst is to provide the catalyst on a structural support. For example, the metal silicide may be obtained as a powder and this powder is adhered to a support, where the supported metal catalyst is then added to the STC converter. This is an example of ex situ formation of supported metal catalyst. Another approach is to place high surface area metal (that is, metal having a high area per unit volume, as found e.g., in metal wool) and place this in the STC converter. The exposure of this high surface metal to one or more of STC, TSC and DSC will convert at least some of the surface of the metal, and if the thickness of the metal is sufficiently small, then the entirety of the metal support, into metal silicide. Thus the metal silicide catalyst may be in the form of wool or wire, which has been formed in situ and is of sufficient structural integrity that the support maintains its morphology under the operating conditions of the STC converter. Under yet another approach, the catalyst is formed on dumped packing, also known as structured packing, and the silicide forms a layer on the surface of the packing, with unconverted metal existing underneath the metal catalyst. Examples of dumped packing include 316 stainless steel, Pall™ rings, and metal sponge which is a type of porous metal. In general, the catalyst can be formed in situ or ex situ. When formed in situ, the catalyst will typically have sufficient mechanical stability to maintain its morphology even under the pressure created by the flow of the gasses through the STC converter. Thus, the shape of the catalyst may be selected to provide for higher efficiency of catalysis. For example, the catalyst may be provided in the form of shaped metal pieces with a high aggregate surface area, or it may take the form of fine wire mesh, as two examples.

When a metal catalyst is utilized in the STC converter, the operating temperature of the converter is reduced compared to a conventional STC converter operating at about 1100° C. In various embodiments, the operating temperature ranges from about 100° C. to 700° C., or about 300° C. to 600° C., or about 450° C. to 550° C., or about 500° C. when catalyst is present. The operating temperature of the STC converter including a metal catalyst is preferably less than 700° C. The maximum pressure within the catalyst-containing STC converter operating at less than 700° C. will, in various embodiments, be within the range of from 0.5 atm. absolute to 20 atm. absolute, or from 1.0 atm. absolute to 12 atm. absolute, or from 3.0 to 9.0 atm. absolute, or is about 6 atm. absolute.

When a metal catalyst is utilized in the STC converter, an optional process of the present disclosure comprises including HCl in the feedstock to the STC converter. The HCl assists in activating the catalyst, and does not deter the formation of TCS. Accordingly, in one embodiment of the present disclosure, the feedstock includes HCl along with STC and H₂, and optionally other components. According to the present disclosure, by adding HCl to the feedstock, STC conversion may be increased compared to that obtained when the converter is operated under equilibrium conditions at temperatures ≦800° C. without the presence of HCl in the feedstock, by an order of at least 1.5×, or at least 2×, or at least 3×.

In various embodiments, the level of HCl in the feedstock delivered into the converter is maintained at ≧0.01 mole %, ≧0.05 mole %, ≧0.1 mole %, at ≧0.5 mol %, at ≧2 mol %, or at ≧3 mol %, or at ≧5 mol % HCl based on the total number of moles of components in the feedstock. For each of those various embodiments, it may optionally be specified that the level of HCl in the feedstock is ≦20 mol %, or ≦15 mol %, or ≦10 mol %, or ≦6 mol % based on the total number of moles of components in the feedstock.

As another option, the STC converter may be operated under non-equilibrium conditions. In conventional operation, and even in the presence of catalyst, an STC converter achieves an equilibrium condition between the amounts of STC and TCS (and other reactants, such as DCS) within the reactor. The amount of TCS produced at thermal equilibrium can be calculated by well-known models. The Gibb's Free Energy Minimization model is one such model, and by way of illustration, thermal conversion of STC in hydrogen to TCS is calculated as a function of temperature as is shown in the following table, where “Percent STC conversion to TCS” refers to the percentage of STC that enters the converter and which is converted to TCS, in other words, the number of moles of TCS exiting the converter in a given period of time, divided by the number of moles of STC entering the converter during the same period of time, multiplied by 100.

TABLE

| Reaction | | | |
|---|---|---|---|
| Temperature | Percent STC conversion to TCS | | |
| (° C.) | For 2:1 (H₂:STC) | For 3:1 (H₂:STC) | For 4:1 (H₂:STC) |
| 200 | 0.11 | 0.13 | 0.15 |
| 300 | 0.53 | 0.65 | 0.75 |
| 400 | 1.6 | 1.9 | 2.2 |
| 500 | 3.5 | 4.3 | 4.9 |
| 600 | 6.3 | 7.7 | 8.8 |
| 700 | 9.8 | 11.9 | 13.7 |
| 800 | 13.8 | 16.7 | 19.1 |
| 900 | 18.0 | 21.8 | 24.8 |
| 1000 | 22.2 | 26.8 | 30.4 |
| 1100 | 26.3 | 31.5 | 35.6 |
| 1200 | 30.0 | 35.9 | 40.4 |

The percent STC conversion to TCS at thermal equilibrium is seen from the Table to be a function of the reaction temperature, where higher reaction temperature favors the formation of TCS. These calculated values compare favorably to the conversions actually observed under currently practiced operating conditions for converters, where those converters operate to achieve thermal equilibrium. Not obvious from these values is that the time to reach thermal equilibrium is relatively long, in fact commercially unacceptably long, when the reaction temperature of the converter is less than about 1,000° C., and certainly when it is less than 800° C. A catalyzed process allows a converter to convert STC to TCS in a reasonable length of time at temperatures below 1,000° C., or below 800° C. However, the yield of TCS under these low (under about 1,000° C.) temperature conditions is not very good, only up to about 14% when the feedstock has a H₂:STC ratio of 2:1. While it is possible to increase that conversion by including more hydrogen in the feedstock, such an approach is ultimately counterproductive because although the conversion becomes higher, the feedstock has much less STC to start with, so the overall amount of TCS produced is reduced. All things considered, the current industry practice is to operate at high temperature (ca. 1100° C.) and low H₂:STC ratio (ca. 2:1) in order to achieve a maximal amount of TCS via the conversion process.

However, the STC converter may be operated in the present process, with or without catalyst, in a non-equilibrium mode. By utilizing a non-equilibrium mode, the process may provide at least 5% more STC conversion than a corresponding process run to thermal equilibrium. For example, when a catalytic reactor is operated at 500° C. with a 2:1 H₂:STC feedstock to achieve thermal equilibrium, that process will achieve a 3.5% conversion of STC to TCS per pass through the converter. The corresponding non-equilibrium process provides, in various embodiments, at least 5% STC conversion, or at least 10% STC conversion, or at least 15% STC conversion, or at least 20% STC conversion, or at least 25% STC conversion.

In order to obtain non-equilibrium conversion of STC to TCS in an STC converter, it is important to control the hold-up time of the reactants within the STC converter. Starting materials will enter the converter as a feed gas, and products will exit the converter as a product gas. The time between when a starting material enters the converter as a feed gas, and when that starting material exits the converter in the form of a product gas, is referred to herein as the hold-up time. The holdup time of the process may be controlled in order to control the length of time a reactant is present within the converter while it is being converted to a product.

More precisely, the holdup time is determined based on the free volume of the converter, and the flow rate of the gas through the converter. The converter free volume refers to the difference between the total volume within the converter (assuming nothing is in the converter) and the volume of the materials (primarily the catalyst and the support for the catalyst) that are placed into the converter and are present in the converter during converter operation. This difference is effectively the volume occupied by the product and feedstock gases within the converter. Converter free volume is measured in terms of volume units, for example, liters. Flow rate refers to the amount of gas that enters the converter in a selected period of time. The amount of gas may be characterized in various ways. For example, the volume of gas at a specified temperature may be used to characterize an amount of gas. As another example, the moles of gas that enter the converter is a way to characterize a gas amount. As used herein, flow rate is measured in terms of gas volume (at a specified temperature) entering the reactor per second. Holdup time is calculated by dividing converter free volume by flow rate, to provide holdup time in units of seconds.

The holdup time should not be too long or too short, and will depend in part on the operating temperature of the STC converter. In general, the converter hold up time can vary from a (theoretically) lower value of 0, which would be achieved if the feedstock instantaneously traveled through the converter, to an upper value on the order of minutes, assuming the product gases are indefinitely stable under the operation conditions within the converter. The hold-up time can be seen to fall within one of five regions, which will arbitrarily be identified herein as regions A, B, C, D and E. Region A is achieved with the shortest hold-up times. In Region A, the converter holdup time is so short that the reaction within the converter does not have sufficient time to reach thermal equilibrium. In this region A, the % of STC conversion is at a non-equilibrium level, and is relatively low because there is inadequate time for the conversion of STC to TCS to take place. On the opposite end of the spectrum is Region E, where the converter holdup time is sufficiently long that the conversion of STC to TCS achieves thermal equilibrium, and furthermore the holdup time is so long that variation of the holdup time by, e.g., 5% or 10% does not have any impact on the level of STC conversion. Current commercial converters operate in Region E. In the middle is region C. Region C is the optimal holdup time, the so-called “sweet spot”. In region C, the fast forward reaction of STC to form TCS has proceeded to a maximum extent relative to the slow back reaction of TCS converting back to STC. In other words, the relatively fast reaction of STC to form TCS has taken place, and the relatively slow reaction whereby TCS is converted back into STC has had a minimal impact on the relative amounts of STC and TCS within the reactor. In region B, the holdup time must be increased in order to obtain a concomitant increase in % STC conversion, while in region D the holdup time must be decreased in order to obtain an increase in % STC conversion. The non-equilibrium operating condition of an STC converter employs a hold up time within regions A-D, and preferably employs a hold up time in regions B-D, which are the supra-equilibrium regions, and more preferably employs a hold up time within region C, which is the maximum supra-equilibrium region. When the STC converter employs operation parameters that provide for non-equilibrium % STC conversion above thermal equilibrium, as achieved in regions B, C and D, then the converter is said to operate under supra-equilibrium conditions and provide supra-equilibrium levels of TCS.

In summary, if the holdup time is too long, then the conversion will proceed to thermal equilibrium, providing a lower than desired conversion of STC to TCS. If the holdup time is too short, then the feedstock is not exposed to the reaction conditions inside the converter for a long enough time for a desired amount of the STC in the feedstock to convert to TCS. In various embodiments, for an operating temperature in the range of 500-700° C., the holdup time ranges from 0.1 seconds to 30 seconds, or from 0.5 seconds to 20 seconds, or from 1 second to 10 seconds, or from 2 seconds to 5 seconds, or is about 3 seconds. The exact value of holdup time needed to achieve % STC conversion in regions B, C or D, and preferably in region C, will depend on other operation parameters. For example, the concentration of the components of the feedstock, and the temperature and pressure inside the converter, and the catalyst loading in the converter, are operational parameters that will impact % STC conversion for a selected holdup time for a catalytic converter operating under non-equilibrium conditions.

The STC converter may be operated both in the presence of a catalyst and under non-equilibrium conditions, optionally with HCl as part of the feedstock. In such a case, the converter is loaded with catalyst and then the converter is brought to a temperature below 1,000° C., optionally within the range of 300-800° C. In one embodiment, the operation parameter that is most easily varied to achieve non-equilibrium or supra-equilibrium conversion of STC to TCS is the flow rate of the feedstock into the converter. For any particular converter configuration and feedstock composition, it is straight-forward to select an operating pressure and temperature, the temperature being within the range of 300-800° C., and then vary the volumetric flow rate (also referred to as feed rate) while measuring the % STC conversion. In this way, the regions A through E for a particular converter and feedstock and operating temperature and pressure can be determined and employed in the process of the present disclosure.

Accordingly, the disclosure provides a process comprising (a) introducing silicon tetrachloride and hydrogen to an STC converter and recovering an off-gas comprising hydrogen chloride and M3; and (b) introducing the off-gas from the STC converter and metallurgical grade silicon (MGSi) to a chlorination reactor under reactor operating conditions comprising a temperature of 250-350° C. and a pressure of 2-33 barg for a time sufficient to convert MGSi to an exit gas comprising trichlorosilane, where the step (a) may be, in various embodiments i) a conventional STC conversion operating at about 1100° C. and 6 barg, or ii) a catalytic STC conversion operating in the presence of a metal catalyst and an operating temperature of less than 800° C., or iii) a non-equilibrium STC conversion wherein the hold-up time is too short for the reactants to reach thermal equilibrium, or iv) a catalytic and non-equilibrium STC conversion which operates at a temperature of less than 800° C. in the presence of a metal catalyst and a hold-up time which is below that necessary to achieve thermal equilibrium between the reactant STC and the product TCS.

Overall then, in one aspect the present disclosure provides a process for converting STC to TCS via a 2-stage, tandem process that achieves improvements relative to the direct chlorination and the STC hydro-chlorination processes. This 2-stage process may advantageously achieve one or more of:
Compared to direct chlorination, eliminate the requirement for an STC hot converter since the STC converter used to convert STC and hydrogen to TCS and HCl may operate under low temperature, i.e., about 600° C., catalytic conditions;
Compared to direct chlorination, eliminate the need to separate, i.e., fractionate the STC hot converter products, typically comprising DCS, TCS, STC, and HCl, using a conventional vent gas recovery (VGR) system.
Compared to STC hydrochlorination, substitute two reactors operating at relatively low temperature and low pressure for the high temperature (typically about 500° C.), high pressure (typically about 33 barg) STC hydrochlorination reactor.
Compared to STC hydrochlorination, enable the use of far less costly, more readily available materials (for example, carbon steel, such as 321 SS and 347 SS) for the construction of the fluid bed reactor, compared to the high cost materials (for example, INCOLOY™ alloys such as INCOLOY 800H™) typically used to manufacture STC hydrochlorination reactors.
Compared to direct chlorination, use significantly less electricity per kilogram of polysilicon produced (˜20 KwHr/Kg less)
Compared to STC hydrochlorination, eliminate the need to superheat hydrogen and STC feed gases to an STC hydrochlorination reactor.
Compared to STC hydrochlorination, achieve much higher STC conversion per pass across an STC converter, at 30% to 40% per pass, compared to STC hydrochlorination at only 20% to 25% per pass.
Compared to STC hydrochlorination, achieve much higher TCS concentration in the product gas from the fluid bed reactor—up to 35 wt. % on a hydrogen free basis, compared to STC hydrochlorination at only 15 wt. %.
Significantly improve inherent process safety compared to STC hydrochlorination.

Operation of the 2-stage process for converting STC to TCS is illustrated by the following information. A feed stock is prepared by feeding 100 moles of STC into a reactor, under conditions where 30% of the STC is converted to TCS. In this case, for every 100 mole of STC fed into the first stage, 30 mole of TCS and 30 moles of HCl are produced. Up to 100% of the HCl present in this first stage product gas converts to TCS in the second stage reactor. The product gas from the second stage reactor contains up to 40 moles of TCS, and 70 moles of STC (i.e., up to 36.4 mole % TCS or 31.3 wt. % on a hydrogen-free basis).

Embodiments of the present invention are based on the discovery that the nexus of improvement required to significantly improve STC hydrochlorination technology is the STC converter. This discovery underlies a new process that combines an STC converter, operating in a way that is a dramatic departure from current technology, with a reactor that functions, in and of itself, as a direct chlorination reactor. The combination of these two reactors into one system is similar to STC hydrochlorination in that STC and MGSi are co-fed with hydrogen gas into the combined system, thereby producing a product gas comprised of TCS, hydrogen, and un-converted STC. It is different in the following key respects:
There may be two separate reactors. The first converts STC to TCS and HCl in a low temperature, catalytic reactor, controlled in a way that thermodynamic equilibrium is not allowed to be achieved. The second reactor reacts HCl from the first reactor with MGSi, thereby producing additional TCS.
The first reactor runs at much lower temperature compared to those employed in conventional STC converter reactors.
The second reactor runs at much lower pressure and temperature compared to those employed in conventional STC hydrochlorination reactors.

In the first stage, STC, in the presence of a stoichiometric excess of hydrogen, is converted to TCS and HCl, according to the same chemistry as for the hot STC converter. However, because it is a catalyzed, non-equilibrium controlled reactor, the conversion reaction occurs at low temperature (less than 800° C., e.g., 350 C.) and low pressure (less than 15 barg, e.g., 5 barg). The product gases from the first stage are then passed directly, without intervening isolation or storage, into the second stage reactor. In the second stage reactor, the HCl produced in the first stage reactor is reacted with MGSi according to the same chemistry as utilized in a direct chlorination reactor. The TCS produced in the first and second stages is thereby combined, resulting in high overall STC conversion compared to current industrial art for STC hydrochlorination.

The presence of the hydrogen from first stage product gas has no adverse effect on the process conducted in the second stage reactor, and indeed has the beneficial effect of suppressing the formation of STC in the second stage. The STC in the first stage product gas has the propitious effect of increasing the conversion of the HCl to additional TCS over the formation of STC in the second stage. This inventive combination may be viewed as a hybridization of conventional direct chlorination and STC hydrochlorination with synergistic benefits not possible with each acting alone.

In one embodiment, the present invention provides a process that includes introducing feedstock materials comprising hydrogen chloride as a first material (M1), metallurgical grade silicon (MGSi) as a second material (M2) and a third material (M3) which may be one or more of silicon tetrachloride (STC), trichlorosilane (TCS), dichlorosilane (DCS) and hydrogen (H₂), into a reactor, and withdrawing an exit gas from the reactor, where the reactor is operated at a temperature of 250-400° C. and a pressure of 2-15 barg, for a time sufficient to convert the metallurgical grade silicon to trichlorosilane as a component of the exit gas. Taking trichlorosilane as an exemplary M3, but understanding that any of STC, DCS or H₂ may be substituted for TCS in the following embodiments, the invention further optionally provides embodiments wherein: the trichlorosilane is introduced into the reactor in a gas phase; the hydrogen chloride is introduced into the reactor in a gas phase; the trichlorosilane and hydrogen chloride are introduced to the reactor as an admixture; the admixture also comprises one or more other members selected from M3 options, e.g., STC, DCS, and/or H₂ (e.g., the admixture also comprises silicon tetrachloride, or the admixture comprises silicon tetrachloride, trichlorosilane, hydrogen chloride and hydrogen), where optionally the admixture may be the reaction product of a reaction between silicon tetrachloride and hydrogen such as may be formed when silicon tetrachloride and hydrogen are combined at a temperature of 300-400° C. and a pressure of 3-7 barg for a time sufficient to generate the admixture and optionally wherein the silicon tetrachloride and hydrogen gas are combined in the presence of a packed bed of metal silicide catalyst in order to form the admixture; the molar ratio of hydrogen to trichlorosilane in the admixture ranges between 1:1 to 6:1; the admixture is combined with a diluent feed comprising hydrogen chloride, the diluent feed including less than 5 mol % silicon tetrachloride; the reactor is a fluidized bed reactor; Lewis acid(s) is present within the reactor; the reactor comprises a dip tube for introducing metallurgical grade silicon; the process is operated in a continuous manner where reactants are continuously entering the reactor and products are continuously exiting the reactor; the reactor comprises a cooling element which conducts heat away from an internal portion of the reactor where metallurgical grade silicon is converted to chlorosilane; the reactor is constructed from materials comprising carbon steel; the trichlorosilane (or other selected M3) and hydrogen chloride are introduced into a fluidized bed comprising metallurgical grade silicon; the exit gas comprises less than 5 mol % hydrogen chloride, based on the mole % of chloride of components of the exit gas; an aliquot of the exit gas comprises a total number of moles of components, and hydrogen chloride constitutes less than 5 mol % of the total number of moles of components. Any two or more of these separate embodiments may be combined to provide a statement of the present invention.

Any of the various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A process comprising combining hydrogen chloride, metallurgical grade silicon and a third material (M3) selected from silicon tetrachloride, trichlorosilane, dichlorosilane, and hydrogen, in a reactor, under reaction conditions comprising a temperature of 250-400° C. and a pressure of 2-33 barg, for a time sufficient to convert metallurgical grade silicon to an exit gas comprising trichlorosilane.

2. The process of claim 1 wherein hydrogen chloride and the third material are introduced into the reactor in a gas phase.

3. The process of claim 1 wherein hydrogen chloride and the third material are introduced to the reactor as an admixture.

4. The process of claim 3 wherein the admixture has a temperature which is less than the temperature within the reactor.

5. The process of claim 3 wherein the admixture further comprises at least one component selected from hydrogen (H₂), silicon tetrachloride, trichlorosilane and dichlorosilane.

6. The process of claim 3 wherein the admixture comprises silicon tetrachloride, trichlorosilane, hydrogen chloride and hydrogen.

7. The process of claim 3 wherein the admixture is a reaction product of silicon tetrachloride and hydrogen.

8. The process of claim 3 wherein hydrogen chloride constitutes less than 50 mol % of the components of the admixture.

9. The process of claim 3 where the molar ratio of hydrogen to the sum of the moles of the chlorosilanes in the admixture ranges between 1:1 to 6:1.

10. The process of claim 1 wherein the reaction conditions are adiabatic reaction conditions.

11. A process comprising
a) introducing silicon tetrachloride and hydrogen to an STC converter and recovering an off-gas comprising hydrogen chloride and M3; and
b) introducing the off-gas and metallurgical grade silicon to a chlorination reactor under reactor operating conditions comprising a temperature of 250-350° C. and a pressure of 2-33 barg, for a time sufficient to convert metallurgical grade silicon to an exit gas comprising trichlorosilane.

12. The process of claim 11 wherein silicon tetrachloride and hydrogen are combined in the STC converter at a temperature of 300-500° C. and a pressure of 3-15 barg for a time sufficient to generate the off-gas.

13. The process of claim 11 wherein the silicon tetrachloride and hydrogen are combined in the STC converter in the presence of a packed bed comprising metal silicide catalyst and the STC converter operates at an operating temperature of less than 800° C.

14. The process of claim 11 wherein the STC converter operates with a hold up time which is less than a hold up time needed to achieve thermal equilibrium between the STC and TCS in off-gas.

15. The process claim 11 wherein a diluent feed comprising hydrogen chloride and less than 5 mol % silicon tetrachloride is introduced to the STC converter along with the silicon tetrachloride and hydrogen.

16. The process of claim 11 wherein the off gas is cooled to a temperature at least 30° C. below the operating temperature of the chlorinator reactor, prior to being introduced to the chlorinator reactor.

17. The process claim 11 wherein the chlorinator reactor is constructed from materials comprising carbon steel.

18. The process of claim 11 wherein an aliquot of the exit gas is characterized as having a total number of moles of components, and hydrogen chloride constitutes less than 5 mol % of the total number of moles of the components.
